(19) United States
(12) Patent Application Publication
(10) Pub. No.: US 2015/0164137 A1
(43) Pub. Date: Jun. 18, 2015

(54) Tobacco Product Holder

(71) Applicant: John R. Shields, SR., Clermont, FL (US)

(72) Inventor: John R. Shields, SR., Clermont, FL (US)

(21) Appl. No.: 14/016,291

(22) Filed: Sep. 3, 2013

(51) Int. Cl. A24F 13/02; F16M 11/16; B60N 3/12

(52) U.S. Cl. CPC A24F 13/02; B60N 3/12; F16M 11/16

(57) ABSTRACT

A tobacco product holder for holding a tobacco product such as a cigarette, cigar or the like conveniently and removably interfaces with a base or stand and is easily held to permit the tobacco product in its grasp to be consumed, reducing the potential of injury to the fingers which would be present if the tobacco product was held by one's fingers. In some embodiments, the tobacco product holder has two elongate, spring-like arms which embrace and grip the smoking article when the arms are compressed or squeezed by the user. In spring-like compression, when the compressive force exerted by the fingers of the user is relaxed, the device retains the tobacco product and becomes a light weight “handle”, permitting it to be held by holding the tobacco product holder. The tobacco product holder adjustably accommodates smoking articles of different diameters such as cigarettes and cigars.

### FIELD

This invention relates to the field of tobacco products and more particularly to a device for holding a tobacco product such as a cigar.

### BACKGROUND

Smokers of various types of tobacco products, including cigarettes and cigars, often need to temporarily rest that tobacco product to free their hands to do other functions such as answer a phone, wash dishes, etc. In the past, an ash tray was often used having slots or troughs to hold the cigarette or cigar, but often the end of the tobacco product winds up lying in the ashes of past users, especially true for cigars.

Some smokers like to enjoy tobacco products, such as unfiltered cigarettes and cigars, smoking the product to a point where it is difficult to hold without burning one's fingers.

Some smokers like to enjoy tobacco products while partaking in various activities such as golfing, fishing, etc. This often requires a place to rest the tobacco product while, for example, swinging the golf club or reeling in a fish.

What is needed is a holder that will hold a tobacco product while one smokes the tobacco product or while the tobacco product rests.

### SUMMARY

A tobacco product holder for holding a tobacco product, in particular, an elongate and substantially cylindrical smoking article such as a cigarette, cigar or the like which, conveniently and removably interfaces with a stand and is easily held to permit the article in its grasp to be consumed, reducing the potential of injury to the fingers which would be present if the tobacco product was held by one's fingers. In some embodiments, the tobacco product holder has two elongate, spring-like arms which embrace and grip the smoking article when the arms are compressed or squeezed by the user. In spring-like compression, when the compressive force exerted by the fingers of the user is relaxed, the device retains the tobacco product and becomes a light weight “handle”, permitting it to be held by holding the tobacco product holder. The tobacco product holder adjustably accommodates smoking articles of different diameters such as cigarettes and cigars.

In one embodiment, a tobacco product holder system is disclosed including a tobacco product holder. The tobacco product holder has a rounded area for holding a tobacco product under resilient force and has a holder base. The tobacco product holder system includes a base that removably interfaces to the holder base, maintaining the tobacco product holder in an upright position.

In another embodiment, a method of holding a tobacco product is disclosed including providing the tobacco product holder system described previously and applying closure pressure against the finger pads, thereby spreading the arcs apart from each other. Next, the tobacco product is placed between the arcs and the pressure against the finger pads is released, thereby allowing the arcs to close around the tobacco product under resilient force of the arms and holder base.

In another embodiment, a tobacco product holder system is disclosed including a tobacco product holder. The tobacco product holder has a spring-like monolithic body with two elongate arms extending from a holder base wherein the end of one such arm is slotted to receive the other arm when the clip is compressed. Each arm, at a location distal from the base, forms an arc such that when the clip is compressed, the first such arm passes through the second to form a rounded opening to receive the tobacco product and to retain the tobacco product under resilient force when the clip is relaxed. A base is also provided. The base removably interfaces to the holder base, maintaining the tobacco product holder in an upright position.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a perspective view of a tobacco product holder with a detachable stand disengaged.

FIG. 1B illustrates a perspective view of a tobacco product holder with a detachable stand engaged.

FIG. 2 illustrates a side elevation view of the tobacco product holder engaged with a detachable stand.

FIG. 3 illustrates a front elevation view of the tobacco product holder engaged with a detachable base.

FIG. 4 illustrates a perspective view of the tobacco product holder in use holding a tobacco product.

FIG. 5 illustrates a perspective view of the detachable base mounted on an elongated object.

FIG. 6 illustrates a perspective view the detachable base affixed to a vehicle (e.g., golf cart).

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

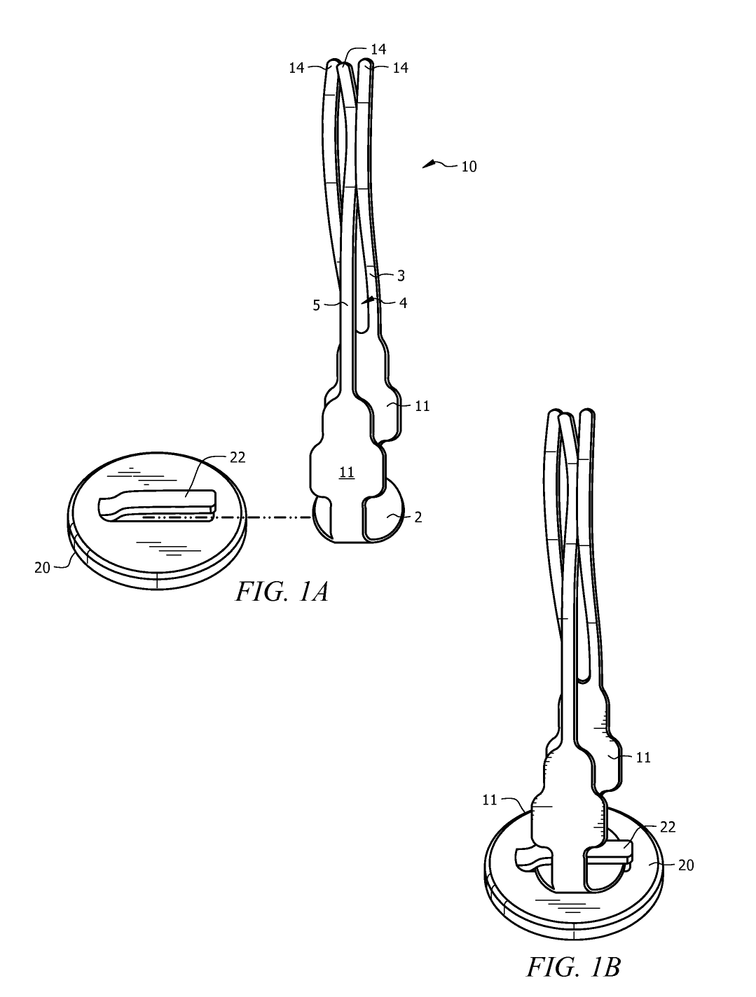

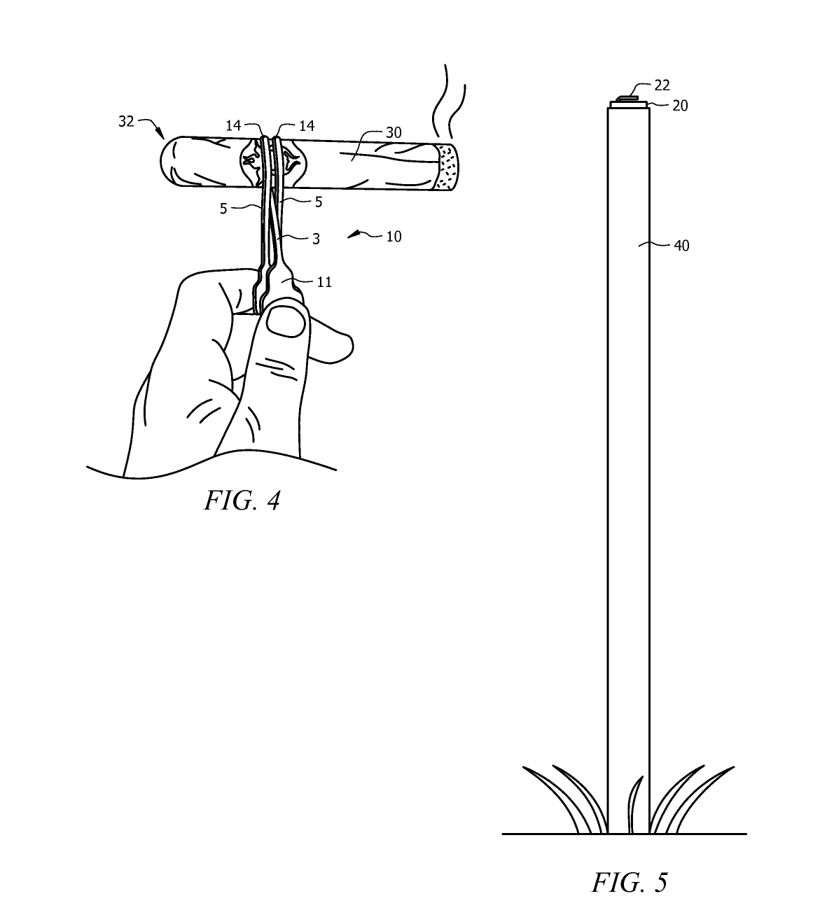

Referring to FIGS. 1A and 1B, perspective views of an exemplary tobacco product holder 10 with a detachable stand 20 are shown. The exemplary holder 10 is of a specific construction as will be described. Although this specific construction of holder 10 is preferred to aid in the gentle holding of a tobacco product (e.g., a cigar 30—see FIG. 4), other shapes, styles, mechanisms are anticipated to hold various tobacco products as long as the holder 10 is removably attachable to a base 10. Likewise, although the specific construction of the base 20 is preferred, many other base styles and shapes are anticipated as long as the base 20 is removably attachable to the holder 10. Although shown as a prong 22 emanating from the base 20, any type of removable attachment is anticipated such as a snap, hook and loop material, a sticky adhesive, a wing nut, etc.

In FIGS. 1A and 1B, the holder 10 is shown in its fully relaxed position. The exemplary holder is characterized by a spring-like monolithic body comprising a base area 2 and elongate arms 3/5 extending from the holder base area 2. The elongate arm 3 has a slot 4 to receive and fully or partially pass elongate arm 5 when the sides of the arms 11 are squeezed or compressed, ordinarily by the thumb and one other finger. In the embodiment shown, the base area 2 is sized to engage with the attachment mechanism of the base 20 (prong 22), so as to stably support the holder 10 and any tobacco product 30 held by the holder when it is rested on or attached to a surface.

The arm 3 confines arm 5, preventing its escape should shear force be inadvertently applied to one arm 3/5 relative to the other arm 3/5 during use. In the preferred embodiment the arms 3/5 are doubly bent or generally S-shaped such that the ends 14 of the arms 3/5 distal from the base 2 present convex surfaces to each other when the clip is in a relaxed position as shown in FIG. 3. At a point intermediate the base area 2 and the arms 3/5, the arms 3/5 are preferably wider relative to their distal ends and form finger pads 11, permitting the device to be comfortably held during use. In some embodiments, it is anticipated that the finger pads 11 are cupped by, for example, bending the edges of the finger pads 11 into flanges otherwise to better accommodate fingertips and ensure a proper grip.

In preferred embodiments, the distal ends 14 are narrow to substantially reduce the portion of the held smoking article 30 occluded by the distal ends 14, permitting the smoking article to be further consumed toward an unlit end of the smoking article 30 than might otherwise be possible for example, if held by one's fingers.

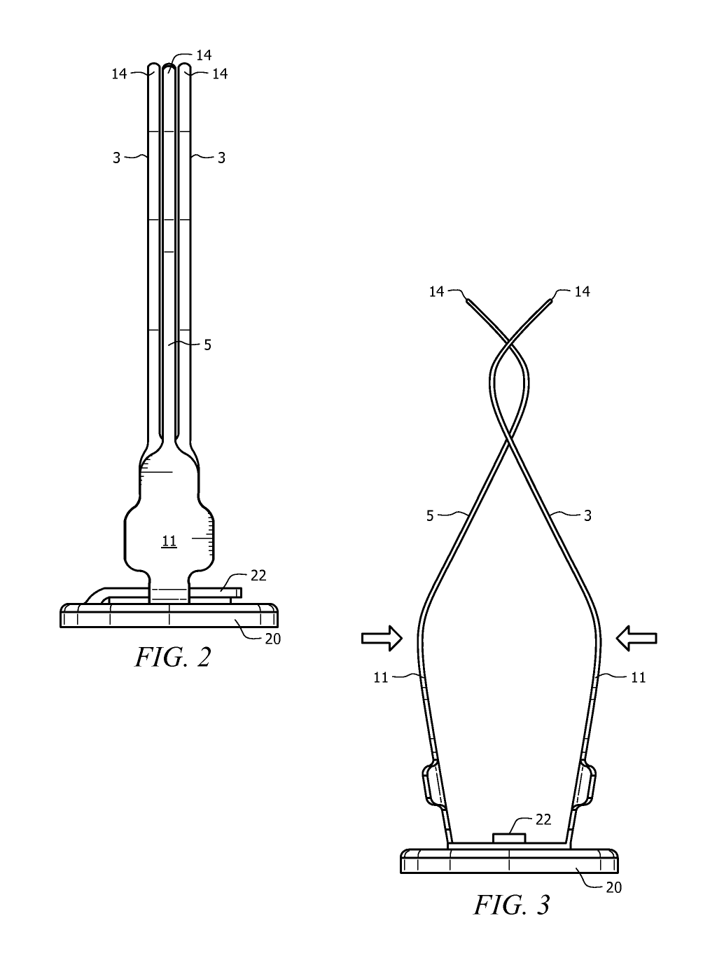

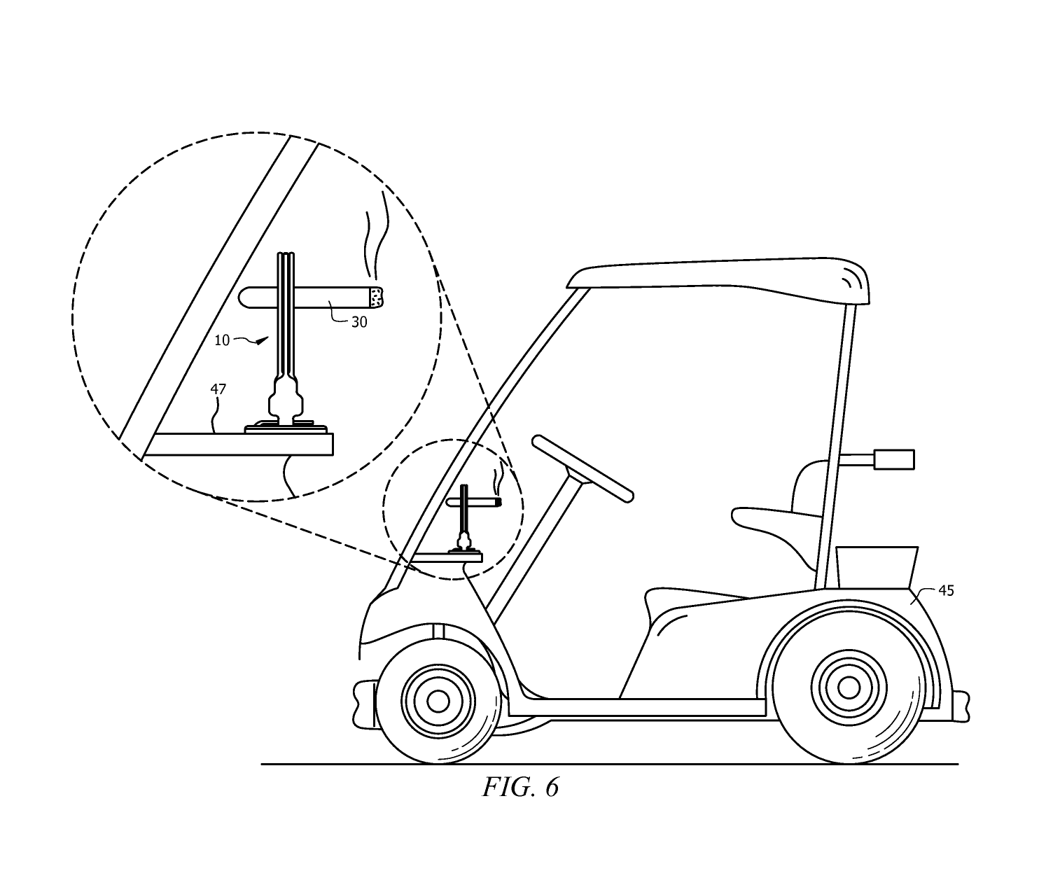

Referring to FIGS. 2 and 3, elevation views of an exemplary tobacco product holder engaged with a detachable stand are shown. Although many removable attachment devices such as snaps, hook and loop material, wing nuts, non-drying glue, etc., are anticipated, the embodiment shown utilizes a prong 22 that is, for example, punched out and bent upwardly from the base 20 creating a gap between the base 20 and the prong 22 into which the base area 2 of the clip 10 is slid and held. In this way, the base 20 removably attaches to the clip 10. It is anticipated that the base 20 provides sufficient counterbalance to hold a tobacco product held within the clip 10 without leaning or falling over. It is anticipated that the base 20 (and prong 22) be made of any suitable material or combination of materials, including, for example, plastic, metal, steel, lead, copper, aluminum, bronze, etc. For stand-alone use (e.g., for resting on a table top), a heavier material such as steel, iron, or lead is preferred to provide sufficient counterweight. In some uses, the base 20 is affixed to another surface such as a dash board of a vehicle 45 (see FIG. 6), a post 40 (see FIG. 5), or any other surface. When the base 20 is affixed to another surface, there is less of a need to make the base 20 from a heavier material and, therefore, lighter materials such as plastic are anticipated. In some embodiments, the bottom surface of the base 20 is coated with an adhesive (not shown) to facilitate sticking to another surface. In some embodiments, the adhesive is covered by a removable, protective cover (also not shown).

Referring to FIG. 4, a perspective view of the exemplary tobacco product holder 10 is shown in use holding a tobacco product 30. In this view, the finger pads 11 were squeezed to allow entry of the tobacco product 30 between the arms 3/5, and then released to gently hold the tobacco product 30 between the arms 3/5. A user then holds the tobacco product holder 10 by, for example, by the finger pads 11 between inhalation episodes of the tobacco product 30. As the tobacco product 30 burns toward the mouth end 32 of the tobacco product 30, the tobacco product holder 10 is moved down the tobacco product 30 towards the mouth end 32, thereby providing a way to hold the tobacco product 30 when it would ordinarily be too small to hold with one's fingers without feeling the heat of the lit end.

Should the user wish to release the tobacco product holder 10, the base end 2 of the tobacco product holder 10 is slid between the base 20 and prong 22 (removably attached to) and the tobacco product holder 10 remains upright, holding the tobacco product 30 above the surface.

Referring to FIG. 5, a perspective view of the detachable stand 40 affixed to or formed on an elongated object 40 is shown. In this embodiment, the base 20 and prong 22 are attached or formed at a first end of a post or other elongated object 40. A distal end of the post or other elongated object 40 is secured or grounded, for example, pushed into soil, sod, or sand, to maintain a generally vertical orientation as shown in FIG. 5. In some embodiments, the distal end of the post or other elongated object 40 is pointed or includes a stake (not shown) to aid in pushing into the soil.

Referring to FIG. 6, a perspective view the detachable base 20 is shown affixed to or integrated within a vehicle (e.g., golf cart 45). In this usage, the base 20 is affixed to a surface 47 of, for example, a golf cart 45 or any other vehicle or object. In such, the base 20 remains with the vehicle or object. When the user wishes to rest the tobacco product holder 10, the user engages the tobacco product holder 10 with the base 20 and the tobacco product 30 is held, set off from the vehicle surface (e.g. dash board 47 or other surface) as shown in FIG. 6. In such, the tobacco product holder 10 retains the tobacco product 30 in a position set off from the vehicle surface (e.g. golf cart 45 dash board 47), even while the vehicle 45 is in motion. A golf cart 45 is used as an example, and any surface of any object is anticipated, not limited in any way to a golf cart.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A tobacco product holder system comprising:
a tobacco product holder, the tobacco product holder having a rounded area for holding a tobacco product under resilient force, and the tobacco product holder having a holder base;
a base, the base removably interfaces to the holder base, maintaining the tobacco product holder in an upright position.

2. The tobacco product holder system of claim 1, wherein the base has body and a prong and the holder base removably slides into a space between the body and the prong.

3. The tobacco product holder of system claim 2, wherein a bottom surface of the base, opposing the prong, is planar so as to rest on a flat surface.

4. The tobacco product holder of system claim 3, wherein the bottom surface of the base includes an adhesive for attaching to another surface.

5. The tobacco product holder of system claim 3, wherein the bottom surface of the base is affixed to a surface of a vehicle.

6. The tobacco product holder of system claim 3, wherein the bottom surface of the base is affixed to an elongated device for supporting the device in any of grass, sod, dirt, and sand.

7. The tobacco product holder of system claim 2, wherein the tobacco product holder comprises:
a spring-like monolithic body having two elongate arms extending from the holder base wherein the end of one such arm is slotted to receive the other arm when the clip is compressed, each arm at a location distal from the base forming an arc such that when the clip is compressed, the first such arm passes through the second to form an opening to receive the tobacco product and to retain the tobacco product under resilient force when the clip is relaxed.

8. The tobacco product holder of system claim 8, wherein each of the two elongated arms has finder pads in proximity of the holder base.

9. A method of holding a tobacco product comprising:
providing the tobacco product holder system of claim 8;
applying closure pressure against the finger pads, thereby spreading the arcs apart from each other;
placing the tobacco product between the arcs; and
abating the pressure against the finger pads, thereby allowing the arcs to close around the tobacco product under resilient force of the arms and holder base.

10. The method of claim 9, further comprising:
providing the holder base of claim 8;
inserting the holder base into the space between the prong and the body of the base; and
resting the base on a planar surface, thereby supporting the tobacco product holder and the tobacco product above the planar surface.

11. The method of claim 10, further comprising the steps of:
removing the holder base from the space between the prong and the body of the base;
smoking the tobacco product; and
re-inserting the holder base into the space between the prong and the body of the base.

12. The method of claim 9, wherein the tobacco product is a cigar.

13. The method of claim 9, wherein the tobacco product is a cigarette.

14. A tobacco product holder system comprising:
a tobacco product holder, the tobacco product holder having a spring-like monolithic body having two elongate arms extending from a holder base wherein the end of one such arm is slotted to receive the other arm when the clip is compressed, each arm at a location distal from the base forming an arc such that when the clip is compressed, the first such arm passes through the second to form an opening to receive the tobacco product and to retain the tobacco product under resilient force when the clip is relaxed;
a base, the base removably interfaces to the holder base, maintaining the tobacco product holder in an upright position.

15. The tobacco product holder system of claim 14, wherein the base has body and a prong and the holder base removably slides into a space between the body and the prong.

16. The tobacco product holder of system claim 15, wherein a bottom surface of the base, opposing the prong, is planar so as to rest on a flat surface.

17. The tobacco product holder of system claim 16, wherein the bottom surface of the base includes an adhesive for attaching to another surface.

18. The tobacco product holder of system claim 16, wherein the bottom surface of the base is affixed to a surface of a vehicle.

19. The tobacco product holder of system claim 16, wherein the bottom surface of the base is affixed to an elongated device for supporting the device in any of grass, sod, dirt, and sand.

20. The tobacco product holder of system claim 14, wherein the tobacco product is selected from the group consisting of a cigar and a cigarette.
